(19) United States
(12) Patent Application Publication
(10) Pub. No.: US 2016/0254998 A1
(43) Pub. Date: Sep. 1, 2016

(54) SERVICE CHAINING USING IN-PACKET BLOOM FILTERS

(71) Applicant: TELEFONAKTIEBOLAGET L M ERICSSON (PUBL), Stockholm (SE)

(72) Inventors: Petri JOKELA, Espoo (FI); András ZAHEMSZKY, Sollentuna (SE)

(21) Appl. No.: 15/032,568

(22) PCT Filed: Oct. 31, 2013
(86) PCT No.: PCT/SE2013/051274

§ 371 Date: Apr. 27, 2016

(51) Int. Cl. H04L 12/741; H04L 12/725; H04L 12/18; H04L 12/721; H04L 29/12

(52) U.S. Cl. CPC H04L 45/745; H04L 45/34; H04L 61/2007; H04L 12/18; H04L 61/2069; H04L 45/30; H04L 61/6022

(57) ABSTRACT

A method of determining routing of a data packet to network nodes providing services in a communications network, a method of routing a data packet to network nodes providing services in a communications network, a device for determining routing of a data packet to network nodes providing services in a communications network, and a device for routing a data packet to network nodes providing services in a communications network.

### TECHNICAL FIELD

The invention relates to a method of determining routing of a data packet to network nodes providing services in a communications network, a method of routing a data packet to network nodes providing services in a communications network, a device for determining routing of a data packet to network nodes providing services in a communications network, and a device for routing a data packet to network nodes providing services in a communications network. The invention further relates to computer programs performing the methods according to the present invention, and computer program products comprising computer readable medium having the computer programs embodied therein.

### BACKGROUND

A service to be provided in response to a piece of input data may be composed of multiple “subservices”, i.e. functions, which perform some actions on the data. On the Internet, a service to be provided can for instance be a firewall that blocks unwanted traffic or it can be e.g. a legal interception, where the input data is redirected for inspection. These individual services, i.e. subservices, can be chained to form a composite service. For example, the traffic can first be delivered to the legal interception service and thereafter to the firewall service.

When data arrives to a network where various services are provided, different data flows may need to pass through a different set of services. This service chaining needs to be managed at a gate node of a domain or network in which the services are provided, via which gate node data enters the network. This node has to maintain information of which services are required for which packets. The most straightforward way of implementing chained services is to physically connect the nodes providing the subservices such that a chain of service-providing nodes is formed. However, this is not a flexible way of implementing composite services since all data packets entering the network must follow the same path and the same set of services on their way through the network.

The destination address (typically an Internet Protocol (IP) address) in an incoming packet cannot be the only key for determining service entities that the packet has to pass, thus the destination address cannot be used directly for forwarding the packet in the service network, also referred to as a Service Chaining Domain (SCD), see FIG. 1. In this domain the packet is forwarded using the mechanism designed for the service chaining.

Source routing provides a mechanism to deliver data using a predetermined path. In IP, strict and loose source routing have been defined. In strict source routing, all the visited nodes are listed in a packet header, and the packet will travel through the determined path. Loose source routing, on the other hand, defines only a few nodes in the network which the packet has to visit. Between the nodes listed in the packet header, standard IP routing is used. Loose source routing has not been widely used due to the security problems.

In-packet Bloom Filters (iBFs) has been proposed as a packet forwarding mechanism, where the main idea of the iBFs is to use source routing in the network and instead of using global IP addresses, to use Link Identifiers (LId) for determining a next hop router in each of the forwarding nodes. The creation of a source routed delivery tree and corresponding forwarding identifier is either centralized or distributed, and the forwarding identifier can even be created en-route depending on the network where the iBFs are used. All the LIds belonging to the tree are inserted in a Bloom filter, providing a fixed size header where the tree can be compressed.

Each LId is defined to be a fixed m-bit long bit string of which k bits are set to one and k<<m. Typical values in iBF implementations are k=5 and m=256. These values can vary depending on the network setup, and works sufficiently well for small to medium-sized multicast groups in typical Wide Area Network (WAN)-wide topologies consisting of hundreds of nodes and links. The k bits can be selected in various ways, even randomly. The packet forwarding iBF is simply created by collecting all the LIds forming the desired tree for the data and logically ORed together in the originally empty iBF bit string. The result is an m-bit long iBF that is inserted in the header of the data packet to be delivered through the network.

Each forwarding node on the path makes a simple verification between the packet's iBF and each of its LIds on outgoing interfaces. The matching is done simply by logically ANDing the interface LId and the iBF in the packet, and if the result is identical to the LId, the node can determine that the interface LId belongs to the tree and it forwards the packet out from that interface.

Multicast is an inherent property of iBF forwarding. The packet is replicated to multiple destinations from a forwarding node if multiple interface LIds have been inserted in the iBF. Due to the probabilistic nature of Bloom filters, there is possibility for false positive results, i.e. the verification may result in a positive answer even if the LId has not been inserted in the iBF. In this case some additional traffic is generated in the network while the packet is forwarded out on a false interface. Note, that the packet will also always follow also the correct path while false negatives are not possible in Bloom filters. It has been shown that with careful design and increased topology awareness, avoiding false positive forwarding is possible even with shorter iBFs.

Further known in the art is Z-formation, an arithmetic operation undertaken for determining the LIds. Each LId for the outgoing interfaces on a forwarding node are calculated on-line when the packet arrives to the forwarding node. The Z-function takes various inputs, e.g. incoming and outgoing interfaces' identifiers, secret key K known only by the forwarding node and the path calculation entity, and packet flow identifier. Based on the input, the Z-function calculates a LId for the outgoing interface and compares if the LId has been inserted in the iBF in the packet or not. If yes, the packet is forwarded out on that interface. Z-formation allows association of the path to e.g. on the input and output interfaces, thus not allowing packet forwarding if it arrives from a different interface with the same iBF in the packet header.

Packets with the same destination IP address may require different set of services and different paths through the SCD network. IP routing cannot be changed in the SCD network to route packets through different service chains. On the other hand, it is possible that the packet may visit a same router more than once and should be forwarded to different next hop routers or nodes depending on the service processing phase it is in. This is not possible to achieve with IP routing.

IP source routing can be used to determine hop-by-hop node visiting and overcome the presented problem with pure IP forwarding. The downside of the source routing solution is that it increases the packet header size. Further, the source routing determines the visiting order only on a node-level, it is not possible to determine potential different service chains inside a unique service providing node.

### SUMMARY

An object of the present invention is to solve, or at least mitigate this problem in the art and to provide improved methods and devices for routing a data packet to network nodes providing services in a communications network.

This object is attained in a first aspect of the present invention by a method of determining routing of a data packet to network nodes providing services in a communications network. The method comprises receiving the data packet, and deriving from the data packet information pertaining to a set of services to be provided by the network nodes. Further, the method comprises determining at least one link identifier for each network node to which the data packet should be routed for the set of services to be provided, each link identifier being configured to identify a communication path on which the data packet is to be routed through said each network node, and creating an in-packet Bloom filter on the basis of the link identifiers and adding the in-packet Bloom filter to the received data packet, said in-packet Bloom filter indicating to which network nodes the data packet should be routed for the set of services to be provided. Finally, the method comprises forwarding the data packet comprising the created in-packet Bloom filter to a first network node providing at least one service comprised in the set of services.

This object is attained in a second aspect of the present invention by a method of routing a data packet to network nodes providing services in a communications network. The method comprises receiving the data packet at one of the network nodes, which data packet comprising an in-packet Bloom filter, and interpreting the in-packet Bloom filter to determine to which further one of the network nodes the received data packet is to be sent. Further, the method comprises forwarding the data packet to said further network node determined by interpreting the in-packet Bloom filter, and providing at least one service indicated in the data packet.

Further provided is a device for determining routing of a data packet to network nodes providing services in a communications network according to the first aspect of the present invention. The device comprises a processing unit and a memory, the memory containing instructions executable by the processing unit, whereby said device is operative to receive the data packet, to derive information from the data packet pertaining to a set of services to be provided by the network nodes, and to determine at least one link identifier for each network node to which the data packet should be routed for the set of services to be provided, each link identifier being configured to identify a communication path on which the data packet is to be routed through said each network node. Further, the device is operative to create an in-packet Bloom filter on the basis of the link identifiers and adding the in-packet Bloom filter to the received data packet, said in-packet Bloom filter indicating to which network nodes the data packet should be routed for the set of services to be provided, and to forward the data packet comprising the created in-packet Bloom filter to a first network node providing at least one service comprised in the set of services.

Further provided is a device for routing a data packet to network nodes providing services in a communications network comprising a processing unit and a memory. The memory contains instructions executable by the processing unit, whereby the device is operative to receive the data packet, which data packet comprising an in-packet Bloom filter, to interpret the in-packet Bloom filter to determine to which further one of the network nodes the received data packet is to be sent, to forward the data packet to the further network node determined by interpreting the in-packet Bloom filter, and to provide at least one service indicated in the data packet.

Still further provided is computer programs performing the methods according to the present invention, and computer program products comprising computer readable medium having the computer programs embodied therein.

Advantageously, the present invention provides a way to determine routing of a data packet through a communications network comprising a plurality of network nodes providing services based on information in the data packet, which routing does not depend the actual destination address of the data packet (typically determined by an IP address). Further, the implementation of in-packet Bloom filters in this particular context provides a compact and fixed sized data packet header as compared to prior art solutions using source routing. Moreover, in-packet Bloom filtering enables use of internal interfaces in a physical network node, thus enabling efficient use of virtual network nodes within the physical network nodes and allowing different service communication paths inside a single physical network node having multiple service functions running. The solution provided by the present invention is flexible; services can be added/removed/duplicated/relocated easily with a low degree of configuration at a coordinating node in the network.

Various embodiments of the present invention will be illustrated and discussed in the detailed description herein below.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 exemplifies a prior art Service Chaining Domain (SCD) in which the present invention can be implemented;

FIG. 2 illustrates a network coordinating device according to an embodiment of a first aspect of the present invention, and network nodes for providing services in the SCD network according to an embodiment of a second aspect of the present invention;

FIG. 3 illustrates the process of interpreting an in-packet Bloom filter at a network node according to an embodiment of the second aspect of the present;

FIG. 4a illustrates a network coordinating device according to an embodiment of the first aspect of the present invention, as well as first and second network nodes comprising virtual nodes according to an embodiment of the second aspect of the present invention;

FIG. 4b shows a flowchart of a method according to an embodiment of the first aspect of the present invention;

FIG. 4c shows a flowchart of a method according to an embodiment of the second aspect of the present invention;

FIG. 4d shows a flowchart of a method according to another embodiment of the second aspect of the present invention;

FIG. 5a illustrates creation of an in-packet Bloom filter using Z-functions according to an embodiment of the present invention;

FIG. 5b shows a flowchart of a method according to an embodiment of the first aspect of the present invention;

FIG. 5c shows a flowchart of a method according to an embodiment of the second aspect of the present invention;

FIG. 6a shows a flowchart of a method according to another embodiment of the first aspect of the present invention;

FIG. 6b shows a flowchart of a method according to another embodiment of the second aspect of the present invention;

FIG. 7 illustrates a device according to an embodiment of the first aspect of the present invention; and

FIG. 8 illustrates a device according to an embodiment of the second aspect of the present invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

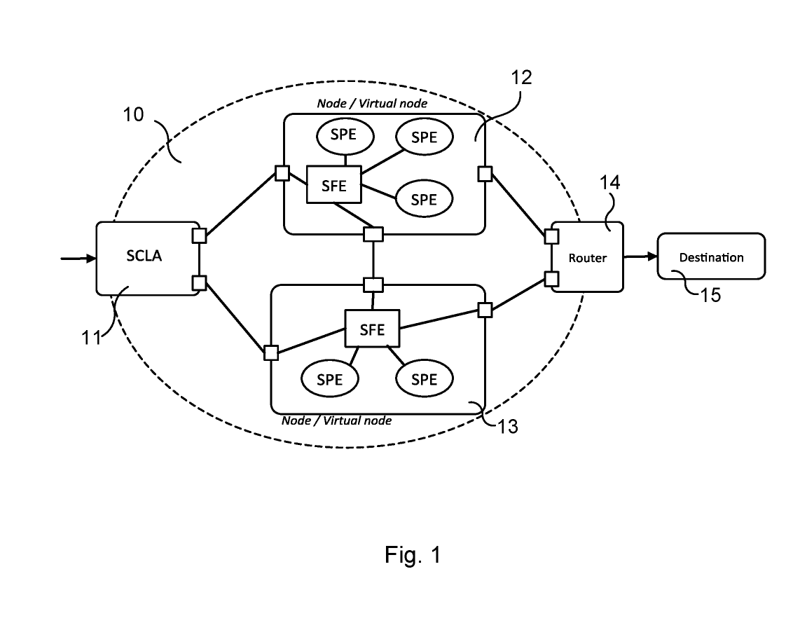

FIG. 1 exemplifies a prior art Service Chaining Domain (SCD) 10 in which the present invention can be implemented. The SCD 10 comprises a Service Classifier (SCLA) 11 acting as a gateway to the SCD and a coordinator for handling routing of data packets throughout the SCD. Thus, for each incoming data packet received by the SCLA 11, a service chain, i.e. a communication path via which the packets are routed, is determined by interpreting packet header information in the incoming packets; for each IP destination, a predetermined path is given via which the packets will travel through the SCD and onto a final destination.

The SCD 10 further comprises physical nodes 12, 13 to which the data packets are to be routed for service provision according to the IP address given in the incoming packet header. Hence, the SCLA 11 routes the incoming packets according to information given in the incoming packet header. A router 14 is arranged at the output of the SCD 10 for delivering the data packets to their originally intended destinations 15 once the set of services has been provided. Each of the nodes in the network has physical interfaces via which data packets may enter and exit. For instance, the first physical network node 12 has in this exemplifying embodiment a first interface towards the SCLA 11, a second interface towards the second physical network node 13 and a third interface towards the router 14. The physical interfaces are illustrated by means of squares.

As is shown in the example of the SCD 10 of FIG. 1, each physical node 12, 13 may comprise virtual nodes. These are illustrated in each physical node 12, 13 as Service Processing Entities (SPEs), being the nodes in the SCD actually providing the services as indicated in the incoming packets. These virtual nodes/SPEs act and operate like physical nodes, but run as software processes. The SPEs are functions residing either inside a physical node or a virtual node and perform actions on the packet to provide an indicated service. A physical node or a virtual node may have a single SPE providing a single service implemented, or may implement a plurality of SPEs providing a variety of services. As further can be seen, the SPEs in each node is operatively coupled to a Service Forwarding Entity (SFE), which locally at each physical node 12, 13 routes the data packets to their intended physical and virtual nodes. Thus, from an SFE point of view, the SPEs appears as virtual/physical nodes when a forwarding decisions is made based on an iBF of a data packet. Even though it is not shown in this exemplifying embodiment, the different SPEs within a physical node may be operatively coupled to each other. Thus, inside each physical node 12, 13, there are virtual interfaces interconnecting various virtual nodes.

As previously has been mentioned, source routing provides a mechanism to deliver data using a predetermined path. In IP, strict and loose source routing have been defined. In strict source routing, all the visited nodes are listed in an incoming packet header, and the packet will travel through the determined path. Loose source routing, on the other hand, defines only a few nodes in the network which the packet has to visit. Between the nodes listed in the packet header, standard IP routing is used. Further, packets with the same destination IP address may require different set of services and different paths through the SCD network. IP routing cannot be changed in the SCD network to route packets through different service chains.

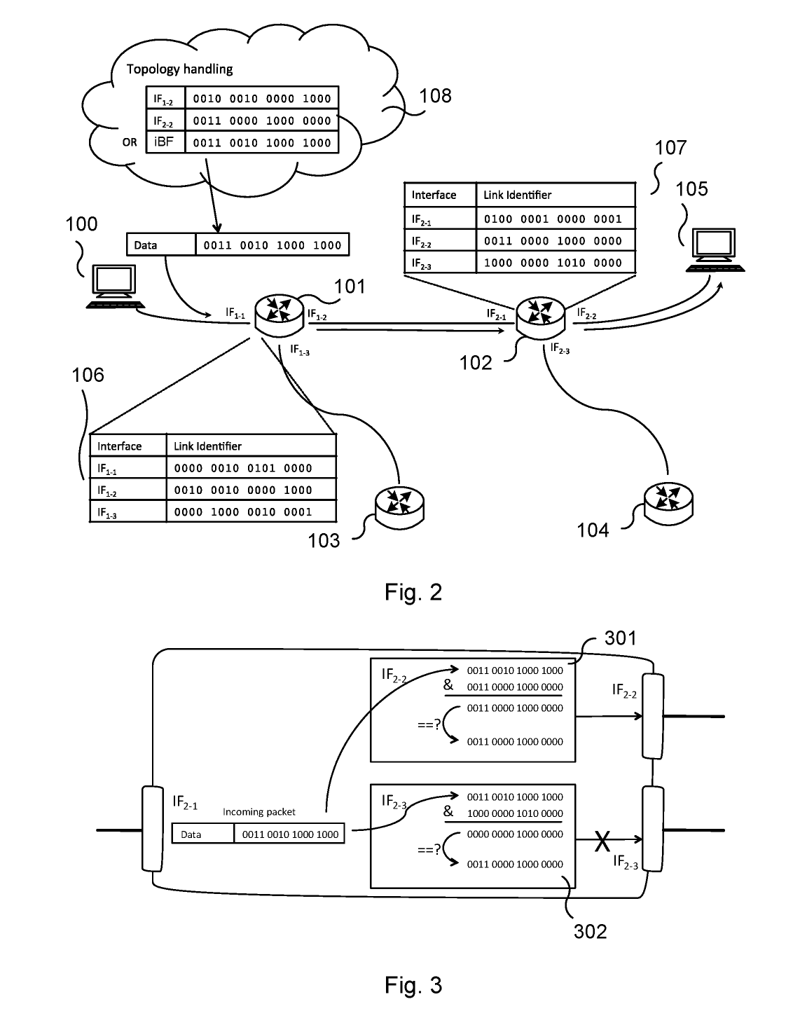

FIG. 2 illustrates a network coordinating device, such as an SCLA 100, according to an embodiment of a first aspect of the present invention. When the SCLA receives a data packet entering the SCD in which the SCLA 100 is the gateway, it derives from the data packet information pertaining to a set of services to be provided by one or more of the network nodes 101, 102, 103, 104 of the SCD. For instance, one service can be provision of a firewall that blocks unwanted traffic, while another can be e.g. a legal interception, where the packet is redirected for inspection. In addition, the services may have to be provided in a specified sequence. The set of services may thus e.g. be defined as (1) providing a firewall and (2) redirecting the packet for inspection.

Further, the SCLA 100 determines at least one link identifier (LId) for each network node to which the data packet should be routed for the set of services to be provided, each link identifier being configured to identify a communication path on which the data packet is to be routed through said each network node. For instance, a first network node 101 has three interfaces, IF₁₋₁ towards the SCLA 100, IF₁₋₂ towards a second network node 102 and IF₁₋₃ towards a third network node 103. and the second network node 102 has one interface IF₂₋₁ towards the first network node 101, a second interface IF₂₋₃ towards the destination 105, and a third interface IF₂₋₃ towards the fourth network node 104.

In FIG. 2, it can be seen that each interface, or communication path is associated with a link identifier; for instance, interface IF₁₋₁ is associated with a link identifier having value 0000 0010 0101 0000, while interface IF₂₋₁ is associated with another link identifier having value 0100 0001 0000 0001, which link identifiers should be unique within the same SCD network. A table for the interfaces/communication paths and the corresponding LIds of the first network node 101 is denoted 106, while a table for the interfaces/communication paths and the corresponding LIds of the second network node 102 is denoted 107. The LIds may be based on e.g. Media Access Control (MAC) addresses of the physical interfaces f the network nodes.

The SCLA 100 is responsible for calculating an in-packet Bloom filter (iBF) for an incoming packet. This iBF is added to the packet header and used for packet forwarding inside the SCD network, which in this exemplifying embodiment comprises the four physical network nodes 101-104. The SCLA determines the services that the packet has to visit, creates the iBF on the basis of the LIds, and adds the iBF to the received data packet.

In this particular embodiment, as exemplified in the above, the received data packet indicates that (1) a firewall is to provided and (2) the packet is to be redirected for inspection. With further reference to FIG. 2, in an embodiment of the present invention, the iBF is created by performing a logical OR operation on the link identifiers associated with the interfaces that the data packet is traverse. Thus, as can be deducted from a topology handling process denoted 108 in FIG. 2, since the packet data is to travel the communication paths identified by interfaces IF₁₋₂ and IF₂₋₂, the corresponding LIds are logically ORed and the resulting product is the iBF, in this case data string 0011 0010 1000 1000, which is added to the data packet. The data packet comprising payload data (denoted “Data”) and the iBF is thereafter sent towards the first service node 101.

Now, FIG. 2 also illustrates devices according to an embodiment of a second aspect of the present invention, namely a network node to provide a service in the SCD network. The network node 101 of the second aspect of the present invention receives the data packet comprising the iBF from the SCLA 100 according to the first aspect of the present invention, and interprets the iBF to determine to which further one of the SCD network nodes the received data packet is to be sent for the set of services indicated in the originally incoming data packets to be provided. Thereafter, as a result of the interpretation of the iBF, the data packet is forwarded to the further SCD network node 102 and the service to be provided by the first network node 101 (in this case firewalling) as indicated in the originally incoming data packet is executed. Depending on the type of service to be provided, the order of forwarding the data packet and providing the service can be changed; i.e. the service is provided before the packet is forwarded.

In analogy with the discussion hereinabove with reference to the SCLA 100 according to the first aspect of the present invention, in an embodiment of the second aspect of the present invention, when the first network node 101 interprets the iBF to determine to which further node the packet is to be routed, it acquires a LId for each communication path on which it is capable of routing the data packet to further network nodes, for instance by turning to a local storage where the LIds are stored. Thereafter, the first network node 101 compares the LId for each communication path with the in-packet Bloom filter and forwards the data packet on the communication path identified by the LId for which there is a match with the iBF. Generally, both the SCLA 100 and the network nodes 101-104 comprise processing units (not shown in FIG. 2) for performing various functions. These processing units will be described in more detail in the following.

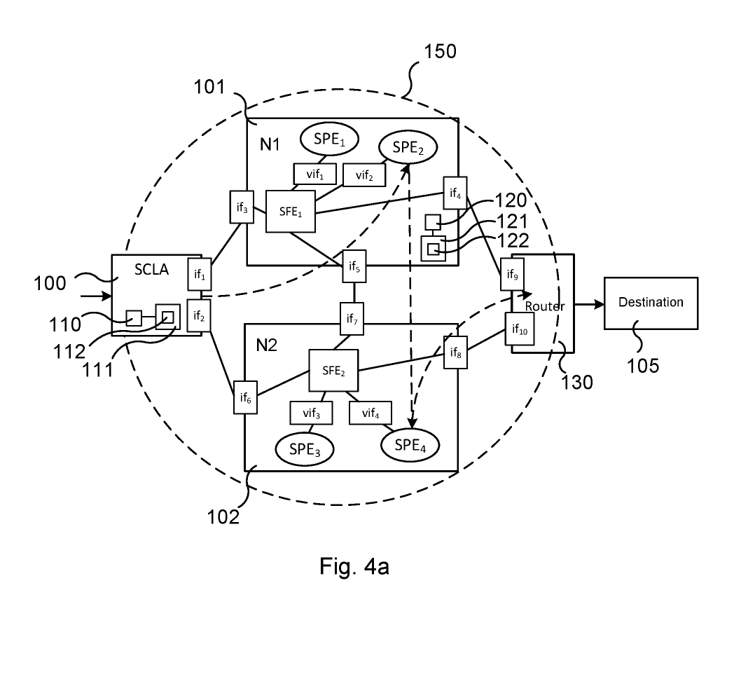

With reference to FIG. 3 illustrating an embodiment of the second aspect of the present, this is described in more detail. In this exemplifying embodiment, the process of interpreting the iBF is undertaken at the second network node 102. When the second network node 102 receives a data packet at interface IF₂₋₁ from the first network node 101, it takes the iBF embedded in the data packet (along with payload data) and performs a logical AND operation with each one of its LIds. As can be seen in the AND operation denoted 301 undertaken for interface IF₂₋₂ at the second network node 102, ANDing of the LId for interface IF₂₋₂ with the iBF will produce a result (0011 0000 1000 0000) which is identical to the LId, and the LId is thus consider to match the iBF. The data packet should thus be routed on the communication path leading from interface IF₂₋₂ to the destination node 105. The routing to the intended destination node 105 will typically be undertaken via a router (not shown) to be discussed in more detail hereinbelow.

In contrast, as can be seen in the AND operation denoted 302 undertaken for interface IF₂₋₃ at the second network node 102, ANDing of the LId for interface IF₂₋₃ with the iBF will produce a result which not is identical to the LId, and the LId is thus not consider to match the iBF. The data packet should thus not be routed on the communication path leading from interface IF₂₋₃ to the fourth network node 104.

As can be concluded from the embodiments of the present invention discussed with reference to FIGS. 2 and 3, the service chaining proposed advantageously enables routing of an incoming data packet to services to be provided such that the routing does not depend on the actual destination (typically determined with an IP address) of the packet; iBF provides a way to determine a source routed path through services. Further, the implementation of iBF in the SCD network provides a compact and fixed sized header when compared to potential other solutions using source routing. Further advantageous is that the implementation of iBF in the SCD network allows using internal (virtual) interfaces, thus providing the possibility to determine different communication paths inside a single node, having multiple service functions running. As previously has been mentioned, these service functions are viewed upon when forwarding the data packets as virtual nodes preferably embodied by means of the software-implemented SPEs. Moreover, the proposed solution is flexible, i.e. services can be added/removed/duplicated/relocated easily with little or no configuration. Only the SCLA need to be updated.

The network node 101 of the second aspect of the present invention receives the data packet comprising the iBF from the SCLA 100 according to the first aspect of the present invention, and interprets the iBF to determine to which further one of the SCD network nodes the received data packet is to be sent for the set of services indicated in the originally incoming data packets to be provided. Thereafter, as a result of the interpretation of the iBF, the data packet is forwarded to the further SCD network node 102 and the service to be provided by the first network node 101 (in this case firewalling) as indicated in the originally incoming data packet is executed. Depending on the type of service to be provided, the order of forwarding the data packet and providing the service can be changed; i.e. the service is provided before the packet is forwarded.

In analogy with the discussion hereinabove with reference to the SCLA 100 according to the first aspect of the present invention, in an embodiment of the second aspect of the present invention, when the first network node 101 interprets the iBF to determine to which further node the packet is to be routed, it acquires a LId for each communication path on which it is capable of routing the data packet to further network nodes, for instance by turning to a local storage where the LIds are stored. Thereafter, the first network node 101 compares the LId for each communication path with the in-packet Bloom filter and forwards the data packet on the communication path identified by the LId for which there is a match with the iBF.

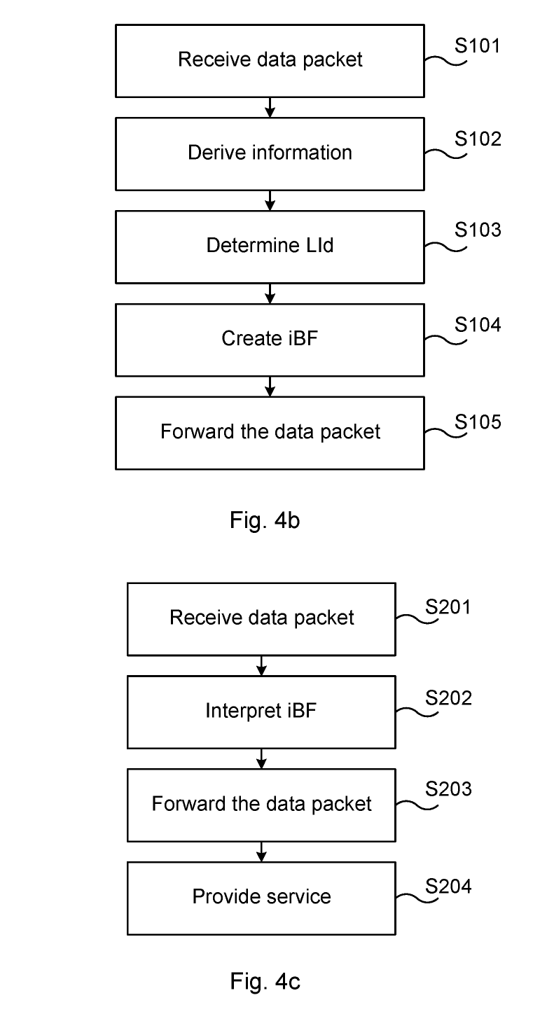

FIG. 4a illustrates an SCLA 100 according to an embodiment of the first aspect of the present invention, as well as first and second network nodes 101, 102 according to an embodiment of the second aspect of the present invention comprised in a SCD network 150. As is shown in the example of the SCD network 150 of FIG. 4a, each physical node 101, 102 may comprise virtual nodes. These are illustrated in each physical node 101, 102 as Service Processing Entities (SPEs) typically running as software processes, being the nodes in the SCD actually providing the services as indicated in the incoming packets, as previously has been discussed. As further can be seen, the SPEs in each node is operatively coupled to a Service Forwarding Entity (SFE), which locally at each physical node 101, 102 routes the data packets to their intended physical and SPEs/virtual nodes. Even though it is not shown in this exemplifying embodiment, the different SPEs within a physical node may be operatively coupled to each other. Thus, the SFE forwards the packets to the different SPE instances inside the physical node or, when the processing at a particular physical node has finished, out to another physical/virtual node.

As can be seen in FIG. 4a, the first physical node 101 comprises a first physical interface if₃ towards the SCLA, a second physical interface if₄ towards the router 130, and a third physical interface if₅ towards the second physical network node 102. Further, the first physical node 101 comprises an SFE denoted SFE₁, two SPEs denoted SPE₁, SPE₂, and two virtual interfaces vif₁, vif₂ between the SFE and the SPEs. Corresponding elements are comprised in the second physical network node 102.

In practice, the method performed at the SCLA 100 of determining routing of a data packet to network nodes providing services in a communications network according to the first aspect of the invention is performed by a processing unit 110 embodied in the form of one or more microprocessors arranged to execute a computer program 112 downloaded to a suitable storage medium 111 associated with the microprocessor, such as a Random Access Memory (RAM), a Flash memory or a hard disk drive. The processing unit 110 is arranged to carry out the method according to embodiments of the first aspect of the present invention when the appropriate computer program 112 comprising computer-executable instructions is downloaded to the storage medium 111 and executed by the processing unit 110. The storage medium 111 may also be a computer program product comprising the computer program 112. Alternatively, the computer program 112 may be transferred to the storage medium 111 by means of a suitable computer program product, such as a floppy disk or a memory stick. As a further alternative, the computer program 112 may be downloaded to the storage medium 111 over a network. The processing unit 110 may alternatively be embodied in the form of a digital signal processor (DSP), an application specific integrated circuit (ASIC), a field-programmable gate array (FPGA), a complex programmable logic device (CPLD), etc.

Similarly, the method performed at the first and second network nodes 101, 102 of routing a data packet to network nodes providing services in a communications network according to the second aspect of the invention is performed (with reference to the first network node 101) by a processing unit 120 embodied in the form of one or more microprocessors arranged to execute a computer program 122 downloaded to a suitable storage medium 121 associated with the microprocessor, as previously has been discussed with reference to the SCLA 100 according to the first aspect of the present invention. In a practical implementation, the processing unit and the SFE of the respective network node is the same functional component, or the processing unit provides the functionality of the SFE.

In the exemplifying embodiment shown in FIG. 4a, the SCLA 100 receives a data packet entering the SCD network 150 in which the SCLA 100 is the gateway. The SCLA 100 has information about the services provided throughout the SCD network 150 and derives from the incoming data packet information pertaining to the set of services to be provided by one or more of the network nodes 101, 102 of the SCD network. In this particular exemplifying embodiment, the processing unit 110 of the SCLA 100 determines that the incoming data packet should be routed via SPE₂ and SPE₄ before exiting the SCD network 150 via the router 130 and being delivered to its intended destination node 105. This route is indicated by the dashed arrow in FIG. 4a.

The SCLA 100 determines the LIds for each network node to which the data packet should be routed for the set of services to be provided, be it a physical node or a virtual node embodied e.g. in the from of an SPE, each LId being configured to identify a communication path on which the data packet is to be routed through each network node. For instance, the communication path from the SCLA to the SPE₂, to which the data packet first is to be routed, is defined by interfaces if₃ and vif₂, i.e. the entering point and exiting point for a first of the communication paths on which the data packet is to be routed through the first network node 101. Further, the communication path leading out from the first network node 101, and consequently in to the second network node 102, is defined by interfaces vif₂ and if₅, i.e. the entering point and exiting point for a second of the communication paths on which the data packet is to be routed through the first network node 101.

Moreover, the communication path from the first network node 101 to the SPE₄, to which the data packet subsequently is to be routed, is defined by interfaces if₇ and vif₄, i.e. the entering point and exiting point for a first of the communication paths on which the data packet is to be routed through the second network node 102. Finally, the communication path leading out from the second network node 102, and consequently in to the router 130, is defined by interfaces vif₄ and if₈, i.e. the entering point and exiting point for a second of the communication paths on which the data packet is to be routed through the second network node 102.

Thus, LIds must be determined for all four communication paths discussed hereinabove. This determination has previously been discussed with reference to FIG. 2, where a data string is associated with each communication path over which the data packet traverses. As previously has been mentioned, the SCLA 100 is responsible for calculating an iBF for an incoming packet. This iBF is added to the packet header and used for packet forwarding inside the SCD network 150. The processing unit 110 of the SCLA 100 thus creates the iBF on the basis of the LIds, and adds the iBF to the received data packet. Thus, in an embodiment, the LIds of the communication paths to be traversed by the data packet is logically ORed by the processing unit no to create the iBF, which iBF is added to the data packet. The data packet is subsequently sent from the SCLA 100 by the processing unit 110 towards the first network node 101.

FIG. 4b shows a flowchart of the method of determining routing of a data packet to network nodes providing services in a communications network according to the first aspect of the invention, performed by a processing unit 110 of the SCLA 100. In a first step S101, the processing unit 110 receives the data packet followed by step S102 where information pertaining to a set of services to be provided by the network nodes are derived from the data packet. In step S103, the processing unit 110 determines at least one LId for each network node to which the data packet should be routed for the set of services to be provided, each LId being configured to identify a communication path on which the data packet is to be routed through said each network node. Thereafter, sin step S104, an iBF is created on the basis of the LIds and added to the received data packet, which iBF indicates to which network nodes the data packet should be routed for the set of services to be provided. Finally, in step S105, the data packet comprising the created iBF is forwarded to a first network node providing at least one service comprised in the set of services.

Again with reference to FIG. 4a, upon reception of the data packet from the SCLA 100, the processing unit 120 of the first network node 101 according to an embodiment of the second aspect of the present invention interprets the iBF comprised therein to determine to which one of the physical or virtual/SPE network nodes the received data packet is to be sent for the set of services indicated in the originally incoming data packet to be provided. As previously mentioned, the functionality of the SFE₁ may advantageously be implemented by the processing unit 120. As a result of the interpretation of the iBF, which in an embodiment is performed by undertaking a logical AND operation between the LId defined by interfaces if₃ and vif₂, the data packet is routed to the virtual node SFE₁ which provides the service (e.g. firewalling) as indicated in the originally incoming data packet. Thereafter, the processing unit 120 interprets the iBF in the data packet and concludes that the data packet should be submitted from the first physical node 101 to the second physical network node 102, a processing unit (not shown) of which in its turn will interpret the iBF, determine that a service is to be provided by the virtual node SPE₄, before deriving the final destination from the iBF, i.e. the router 130, which subsequently will deliver the data packet to its intended destination node 105.

FIG. 4c shows a flowchart of the method of routing a data packet to network nodes providing services in a communications network according to the second aspect of the invention, performed by a processing unit 120 of a network node 101. In a first step S201, the processing unit 120 receives the data packet, which data packet comprising an iBF as previously discussed with reference to the first aspect of the present invention. In a second step S202, the processing unit 120 of the network node 101 interprets the iBF to determine to which further one of the network nodes the received data packet is to be sent. Thereafter, the processing unit 120 forwards in step S203 the data packet to the further network node determined by interpreting the in-packet Bloom filter, and in step S204 at least one service indicated in the data packet is provided.

With reference to FIGS. 4a and c, it should be noted that depending on the structure of a network node, e.g. in case the physical network node 101 comprises virtual nodes/SPEs SPE₁, SPE₂, it is possible that the forwarding of the data packet is forwarded by the network node 101, i.e. in practice by the SFE/processing unit 120 to anyone of its internal virtual nodes to which the packet is intended, wherein the SPE/virtual node provides the required service. However, in case the physical network node 101 does not comprise any further SPEs/virtual nodes, the physical node 101 provides the requested service before forwarding the data packet to a subsequent physical node 102. Thus, the order in which steps S103 in S104 are performed may be transposed.

FIG. 4d shows a flowchart of a further embodiment of the method of the second aspect of the invention. After the processing unit 120 of the first network node 101 receives the data packet in step S201, it interprets the iBF in step S202 by further, as indicated in step S202b, acquiring a LId for each communication path on which the first network node 101 is capable of routing the data packet to further network nodes. Thereafter, in step S202c, the processing unit 120 compares the LId for each communication path with the iBF in the received data packet. Subsequently, in step S203, the data packet is forwarded on the communication path identified by the LId for which there is a match with the iBF and a service is provided in step S204.

In a further embodiment of the present invention, after the packet visited all the physical and/or virtual nodes in the service chain, the data packet may continue to be forwarded towards its destination node 105. However, outside the SCD network 150, the iBF generally does not hold useful information and is likely to not even be understood by routers and switches. Therefore, the last node (virtual or physical) is responsible for removing the iBF from the packet header and forward the packet to the router for delivery the its intended destination node. After the iBF is removed from the packet header, the packet will be forwarded using e.g. Ethernet, IP or Multiprotocol Label Switching (MPLS), etc.

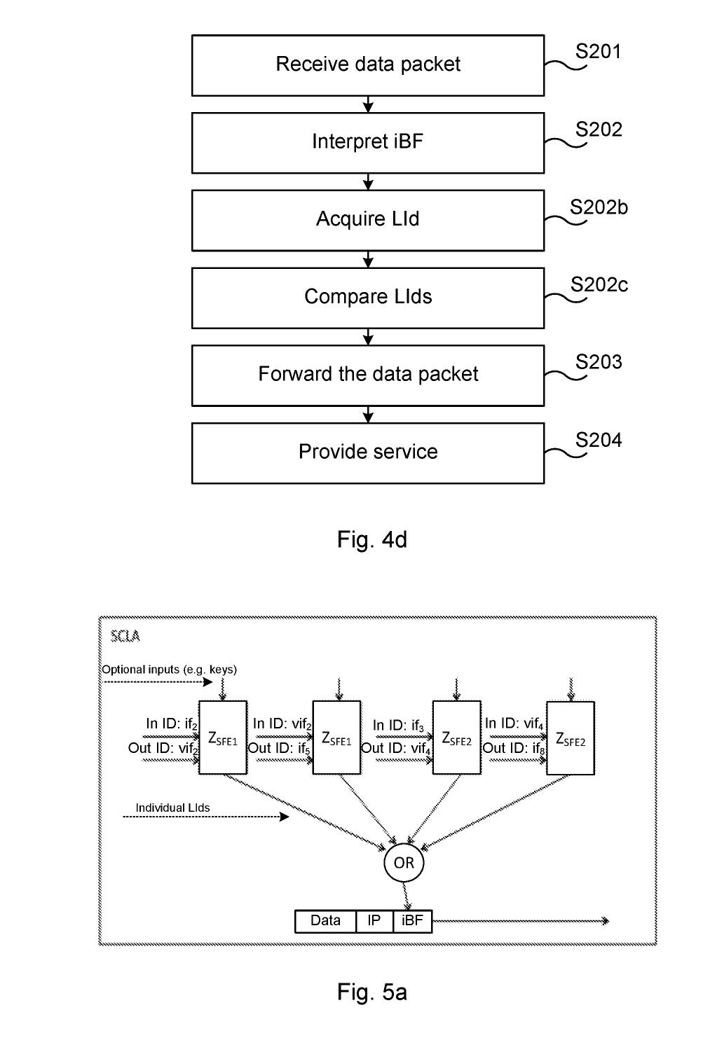

FIG. 5a illustrates yet another embodiment of creating an iBF on the basis of the LIds identifying the communication paths via which the data packet will traverse. Thus, as was discussed with reference to FIG. 4a, the SCLA 100 determines the LIds for each network node, be it a physical node or a virtual/SPE node, to which the data packet should be routed for the set of services to be provided, each LId being configured to identify a communication path on which the data packet is to be routed through each network node. For instance, the communication path from the SCLA to the SPE₂, to which the data packet first is to be routed, is defined by interfaces if₃ and vif₂. As is shown in FIG. 5a, the processing unit 110 of the SCLA 100 will in this particular embodiment perform a so called Z-formation with if₃ and vif₂ as inputs. Hence, if₃ and vif₂ will be input to a Z-function, and the output will be the LId of this particular communication path, i.e. the path from the SCLA 100 to SPE₂. It is possible that each node provides only a single service, in which case it is enough that the packet is routed node-to-node, but as has been illustrated, there may be several virtual nodes/SPEs correspondingly providing multiple service functions within a physical node and if there is a particular node visiting order to comply with, the LId for each of the virtual/SPE nodes providing the services must be determined.

A Z-function can take various inputs, e.g. incoming and outgoing interfaces' identifiers, a secret key K, packet flow identifiers, etc. and produce a LId as an output. Z-formation allows association of a communication path to e.g input and output interfaces, as has been described in the above, thus not allowing packet forwarding if it arrives from a different interface with the same iBF in the packet header. The Z-function is a secure function employed to compute the link identifiers, and based on the inputs, an m-bit long string is calculated, where k bits will have the value of 1, and (m−k) bits will have the value of 0. The Z-function can be implemented as a stream-cipher-like construction, tailored to constantly output (approximately) k bits of 1 instead of the usual average of (approximately) m/2 bits of 1. Internally, the function may resemble a keystream generator, initialized with a combination of various inputs.

Further, the communication path leading out from the first network node 101 defined by interfaces vif₂ and if₅ is input to a Z-function for producing a further LId. The same process is undertaken for the communication paths defined by if₇ and vif₄, and vif₄ and if₈, respectively. As can be seen in FIG. 5a, these four LIds are logically ORed by the processing unit 110 of the SCLA 100, and the result is the iBF which is added as a header to the data packet comprising payload data (“Data”) and optionally an IP address of a final destination node.

FIG. 5b shows a flowchart of the embodiment of the method of the first aspect where Z-functions are used to determine the LIds as has been described in the above performed by the processing unit no of the SCLA 100. After the processing unit no receives the data packet and derives the service information from the data packet in steps S101 and S102, it determines the LIds in step S103 which in this particular embodiment comprises step S103b where a Z-function is performed using at least the data packet entering point and the data packet exiting point for the respective communication path as inputs. Hence, the above mentioned interface identifiers are input to the Z-function for determining the LId of the respective communication path. Optionally, as has been discussed with reference to FIG. 5a, the method may comprise a further step S103c, where a secret key K associated with the respective network node is used as a further input to the Z-function when determining each link identifier. Finally, the processing unit 110 of the SCLA 100 performs steps S104 and S105.

Conversely, in an embodiment of acquiring the LIds at the network nodes 101, 102 where the LIds has been created by the SCLA 100 using Z-functions as discussed in connection to FIG. 5a, a network node will determine where to forward the data packet by using the same Z-functions as the SCLA to create the respective LId. For instance, the processing unit 120 of the first network node 101 will input if₃ and vif₁ to the same Z-function (Z_{SFE1}) as was used by the SCLA 100 to create the LId for this particular communication path. The resulting LId is then ANDed with the iBF and if the product is identical to the iBF itself, there is a match and the data packet is forwarded accordingly. It should be noted that the one and same Z-function could be used for computing each LId. However, the particular Z-function used by the SCLA 100 when creating the iBF must also be used by a network node when subsequently interpreting the iBF.

FIG. 5c shows a flowchart of the embodiment of the method of the second aspect corresponding to that shown in FIG. 5b where Z-functions are used to determine the LIds. The embodiment shown in FIG. 5c is based on the embodiment previously shown in FIG. 4d. After the processing unit 120 of the first network node 110 receives the data packet in S201, it interprets the iBF in step S202 by further, as indicated in step S202b, acquiring a LId for each communication path on which the first network node 101 is capable of routing the data packet to further network nodes. Each LId is determined in step S202b′ by performing a Z-function using at least the data packet entering point and the data packet exiting point for the respective communication path as inputs (i.e. the previously discussed interface identifiers). Thereafter, in step S202c, the processing unit 120 compares the LId for each communication path with the iBF in the received data packet. Subsequently, in step S203, the data packet is forwarded on the communication path identified by the LId for which there is a match with the iBF and a service is provided in step S204.

With reference again to FIG. 4a, in a further embodiment of the present invention, instead of having an SPE, such as SPE₂, process the data packet and return it to the SFE, the virtual node SPE₂ does not return the packet to the SFE for transmission via interface if₅. Rather, the processing unit 120 of the first network node 101 advantageously multicasts the data packet to the network nodes (virtual and physical) indicated in the iBF. In certain cases, it might be beneficial to copy the data packet and send it to two or more service providing network nodes simultaneously, especially if the packet content is not modified by the service provided and there is no reason to return the packet to the sending SFE of the respective physical network node. This can be the case with e.g. legal interception and charging. In a further example, a packet is sent simultaneously to a charging module and to a service responsible for collecting statistics. A simple charging module e.g. only needs to count the bytes of the packet and identify its intended communication path and does not need to modify the packet. Also, the service collecting the statistics does not need to change the packet. In this case the charging module can discard the received copy of the packet. Using multicast in such cases makes the processing faster, while the other service providing nodes do not have to unnecessarily wait for processing the data packet.

As previously has been discussed, Bloom filters are probabilistic data structures and they inherently hold the possibility of false positives, i.e. a tested element's query for membership returns true, even though the element was never added to the Bloom filter. With careful sizing and design, the false positive rate for the in-packet Bloom filters can be kept reasonably low. However, for the proposed service chaining architecture, additional false positive protection can be built with simple modifications/enhancements of the original design.

If a network node is capable of forwarding the data packet to a plurality of further nodes, be it physical nodes or virtual/SPE nodes (both types are shown in FIG. 4a), an embodiment for avoiding false positives is proposed. With reference to FIG. 4a, if the processing unit 120 providing the SFE functionality is connected to multiple SPEs (SPE₁ and SPE₂) and the packet has to visit at least one of them, the processing unit 120 determines from the iBF and the LIds the SPE to visit, in the previous example being SPE₂. If the comparison of the LIds and the iBF results in at least two matches, it can be suspected that at least one is a false positive. Before forwarding the packet to a selected one of the matching SPEs, the processing unit 120 makes a check-up on a next communication path provided the packet first has to visit the selected one of the matching SPEs. If there is no match between the iBF and the next-hop communication path, the processing unit 120 can advantageously be sure that the selected SPE is a false positive and that the packet should not visit that SPE. Hence, the SPE for which the next-hop communication path LId does not match the iBF is dismissed as a false positive. Optionally, the same check can be made for each of the matching SPEs, and the processing unit 120 will be able to conclude to which one of the SPEs it should send the packet data. After this procedure is finished, the SFE will usually be able to determine the correct SPE to send the packet to.

In a further embodiment of the present invention, in the rarely occurring case where a network node still cannot correctly decide the next-hop communication path on which the data packet should be forwarded, the data packet can be returned (or information about the packet/communication paths) to the SCLA inquiring further information. In response to this inquiry, the SCLA can provide a temporary iBF with a single element specifying the next-hop communication path over which the data packet is to be transferred to the SPE to visit. From this temporary iBF, the network node will be able to determine the next-hop communication path and forward the data packet accordingly. Thereafter, the normal procedure of checking the originally created iBF for the data packet can resume.

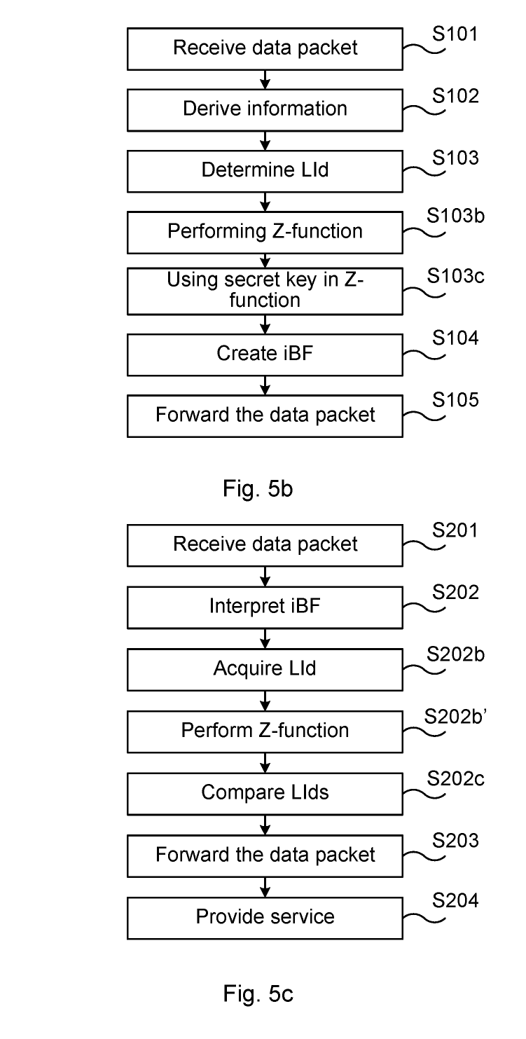

FIG. 6a shows a flowchart of the embodiment of the method of the first aspect where a temporary iBF is used. Thus, when a network node cannot correctly decide a next-hop destination, it will turn to the SCLA 100. In step S106, the processing unit 110 of the SCLA 100 receives an inquiry from the network node where to forward the data packet. In response thereto, the processing unit no creates and sends in step S107 a temporary iBF to the inquiring network node where only the link identifier of a next-hop communication path is included.

FIG. 6b shows a flowchart of the embodiment of the method of the second aspect corresponding to that shown in FIG. 6a where a temporary iBF is used. Thus, when a network node 101 cannot correctly decide a next-hop destination, its processing unit 120 it will turn to the SCLA 100. In step S202d, the processing unit 120 of the network node 101 sends an inquiry to the SCLA 100 where to forward the data packet. In response thereto, the processing unit no creates a temporary iBF, which the inquiring network node 101 receives in step S202e, where only the link identifier of a next-hop communication path is included. After the packet has been forwarded in line with the temporary iBF in step S203 and the service is provided in step S204, the originally crated iBF will be used for determining a destination of the data packet.

In yet another embodiment of the present invention, the network node multicasts the data packet to the further network nodes indicated in the iBF. In response, any one of the further network nodes for which the data packet was not currently intended will indicate to the multicasting network node that a false positive has occurred.

In multicast context, a further embodiment of the present invention will be described. In this embodiment, when using Z-functions to calculate LIds as previously has been discussed in detail with reference to FIG. 5a, a first LId will be used for each communication path in case of unicast, while a second LId will be used for each communication path in case of multicast. Thus, when using the Z-function illustrated in FIG. 5a, three inputs will be used when calculating each LId. For instance, a flag could be employed to indicate whether unicast of multicast of the data packet is to be used. Hence, the first LId could be calculated as:

LId_unicast=Z(0,InId,OutId),

while the second LId could be calculated as:

LId_multicast=Z(1,InId,OutId).

Advantageously, if more than one match is found on the multicast LIds, the data packet is sent simultaneously over the communication paths identified by the multicast LIds to the appropriate network nodes. If only one match is found for the multicast LIDs, the packet is not forwarded as it is a clear false positive.

In another example, it is assumed that a single SFE of a physical node is to forward the data packet to four virtual nodes within the physical node in the form of SPEs, i.e. SPE1, SPE2, SPE3 and SPE4, having interface identifiers vif1, vif2, vif3, and vif4, respectively. In this example, the packet has to be forwarded to SPE1, thereafter it should be sent simultaneously to e.g. SPE2 and SPE3 before finally being forwarded to SPE4 before it leaves the physical node. In other words, the packet can only be processed by SPE4 after both SPE2 and SPE3 received the packet. In an embodiment of the present invention, a new function f is introduced that computes a combined LId from vif2 and vif3, in which case the SCLA computes f(vif2, vif3) and the SFE subsequently processes the function f(vif2, vif3) to determine the next interfaces in the service chain, wherein in this example SPE2 and SPE3 are addressed simultaneously after the packet has passed through SPE1 and before the packet is forwarded to SPE4.

With reference again to FIG. 5a and a further embodiment of the present invention, in certain environments, added security may be required. The Z-function can take advantage of a secure key known only by the network node itself for which a LId is calculated and the SCLA. Thus, this makes it very hard to generate valid LIds and generate an iBF that could be used to falsely deliver packets to certain services without knowing the correct key.

It should be noted that to increase the performance of the SCD network 150 shown in FIG. 4a, it is possible that more than one virtual node (i.e. SPE) being connected to the same processing unit (i.e. SFE) provide the same service. One could also envisage an SCD network 150 where more than one physical node 101, 102 provides the same service (possibly among a large variety of different services). In such an SCD network 150, the network nodes providing the same service will be assigned with same link identifiers, and it is up to the processing unit of the respective network node to determine to which of the network nodes providing the same service the data packet should be forwarded. This decision algorithm of the processing unit can be based on simple load balancing techniques, e.g. round robin with equal probabilities. This embodiment is advantageous for load balancing reasons, and in particular because additional virtual nodes (SPEs) can be comprised in a network node on demand without the need to configure/notify the SCLA.

In yet another embodiment of the present invention, if it is desirable that all data packets in a packet flow is routed to one and the same network node, i.e. even if two or more network nodes provide an identical service, the packet flow should nevertheless be routed to one and the same network node, all data packets in the packet flow will be associated with a flow identifier. The processing unit of the respective network node can thus route the complete packet flow according to the flow identifier.

In still other embodiments of the present invention, in order to enable so called service forking in case the service chain of a data packet cannot be fully determined in the SCLA upon packet arrival, which typically may happen if a Deep Packet Inspection (DPI) function is part of the service chain and the further processing of the data packet thus depends on the result of the DPI, the network node containing the DPI functionality can be allowed to either update the iBF of the data packet by ORing the appropriate LIds to the iBF of the packet thus creating an updated iBF as a result of the DPI, or return the packet to the SCLA informing it about the result of the DPI, wherein the SCLA will compute the updated iBF and send it back to the network node for subsequent packet forwarding. In practice, the handling of this, i.e. either the adding of LId(s) to the iBF to create an updated iBF or the sending of the required LId(s) to the SCLA to create an updated iBF, may be undertaken by an SPE and/or SFE of the network node.

Thus, the SPE or the SFE of the network node returns the data packet to the SCLA being the issuer of the iBF with complementing information where to forward the data packet in line with the result of the DPI. Subsequently, the SPE or the SFE receives an updated iBF where one more link identifiers as indicated in the complementing information has been included such that the data packet can be forwarded to its intended node. Alternatively, the SPE or the SFE of the network node updates the iBF with new link identifiers indicating where to forward the data packet in line with the result of the DPI, to create an updated iBF. The updated iBF is added to the data packet accordingly and forwarded to its intended destination.

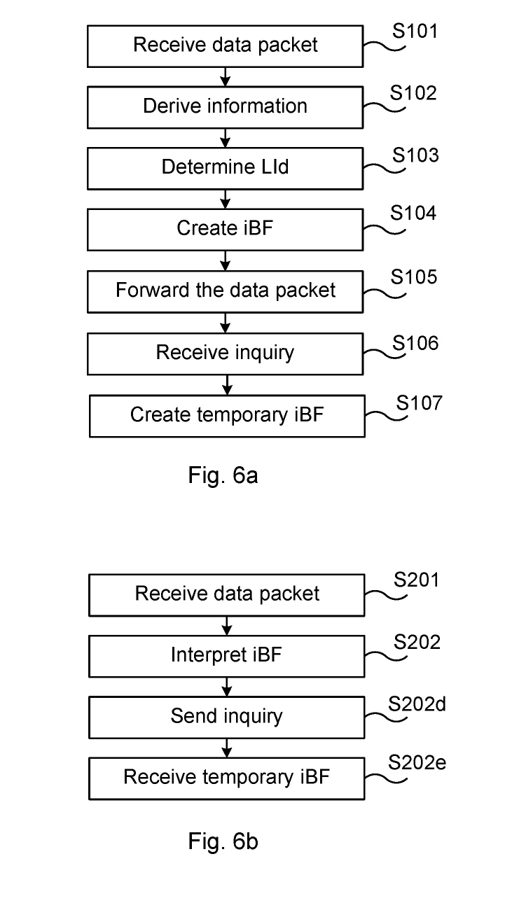

FIG. 7 shows a network coordinating device, such as an SCLA 100, according to an embodiment of the first aspect of the present invention. The SCLA 100 comprises receiving circuitry 201 adapted to receive a data packet, deriving circuitry 202 adapted to derive information from the data packet pertaining to a set of services to be provided by network nodes, and determining circuitry 203 adapted to determine at least one link identifier for each network node to which the data packet should be routed for the set of services to be provided, where each link identifier is configured to identify a communication path on which the data packet is to be routed through said each network node. Further, the SCLA 100 comprises creating circuitry 204 adapted to create an in-packet Bloom filter on the basis of the link identifiers and adding the in-packet Bloom filter to the received data packet, said in-packet Bloom filter indicating to which network nodes the data packet should be routed for the set of services to be provided, and forwarding circuitry 205 adapted to forward the data packet comprising the created in-packet Bloom filter to a first network node providing at least one service comprised in the set of services. The receiving circuitry 201 and the forwarding circuitry 205 may comprise a communications interface for receiving/sending information. The SCLA 100 may further comprise a local storage. The receiving circuitry 201, deriving circuitry 202, determining circuitry 203, creating circuitry 204 and forwarding circuitry 205 may (in analogy with the description given in connection to FIG. 4a) be implemented by a processor embodied in the form of one or more microprocessors arranged to execute a computer program downloaded to a suitable storage medium associated with the microprocessor, such as a RAM, a Flash memory or a hard disk drive. The receiving circuitry 201 and the forwarding circuitry 205 may comprise one or more transmitters and/or receivers and/or transceivers (even combining the receiving circuitry and the forwarding circuitry in the same unit), comprising analogue and digital components and a suitable number of antennae for radio communication.

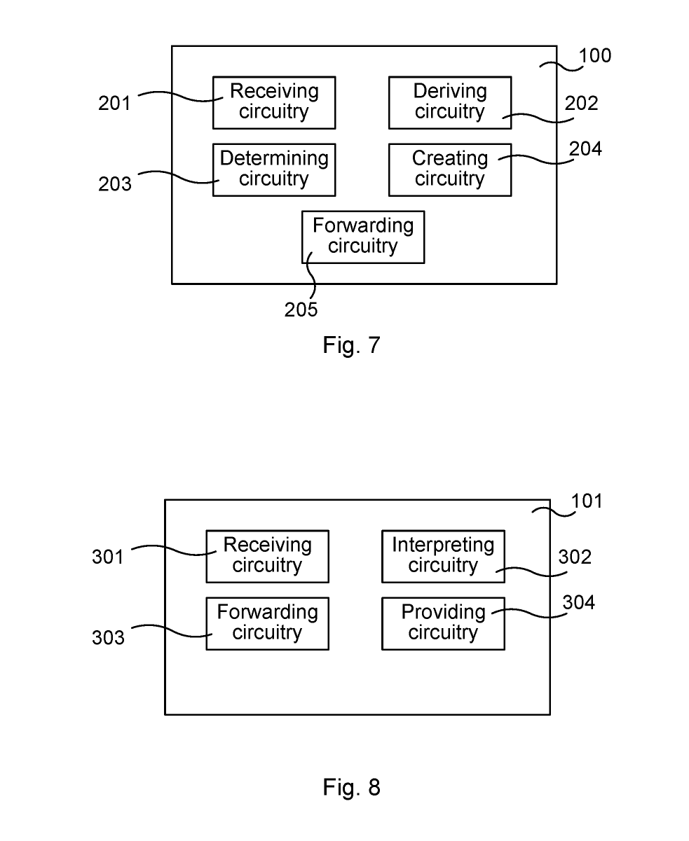

FIG. 8 shows a network node 101 according to an embodiment of the second aspect of the present invention. The network node 101 comprises receiving circuitry 301 adapted to receive a data packet comprising an in-packet Bloom filter, and interpreting circuitry 302 adapted to interpret the in-packet Bloom filter to determine to which further network node the received data packet is to be sent. Moreover, the network node 101 comprises forwarding circuitry 303 adapted to forward the data packet to the further network node determined by interpreting the in-packet Bloom filter, and providing circuitry adapted to provide at least one service indicated in the data packet. The receiving circuitry 301 and the forwarding circuitry 303 may comprise a communications interface for receiving/sending information. The network node 101 may further comprise a local storage. The receiving circuitry 301, interpreting circuitry 302, forwarding circuitry 303 and providing circuitry 304 may (in analogy with the description given in connection to FIG. 4a) be implemented by a processor embodied in the form of one or more microprocessors arranged to execute a computer program downloaded to a suitable storage medium associated with the microprocessor, such as a RAM, a Flash memory or a hard disk drive. The receiving circuitry 301 and the forwarding circuitry 303 may comprise one or more transmitters and/or receivers and/or transceivers (even combining the receiving circuitry and the forwarding circuitry in the same unit), comprising analogue and digital components and a suitable number of antennae for radio communication.

The invention has mainly been described above with reference to a few embodiments. However, as is readily appreciated by a person skilled in the art, other embodiments than the ones disclosed above are equally possible within the scope of the invention, as defined by the appended patent claims.

1. A method of determining routing of a data packet to network nodes providing services in a communications network, comprising:
receiving the data packet;
deriving, from the data packet, information pertaining to a set of services to be provided by the network nodes;
determining at least one link identifier for each network node to which the data packet should be routed for the set of services to be provided, each link identifier being configured to identify a communication path on which the data packet is to be routed through said each network node;
creating an in-packet Bloom filter on the basis of the link identifiers and adding the in-packet Bloom filter to the received data packet, said in-packet Bloom filter indicating to which network nodes the data packet should be routed for the set of services to be provided; and
forwarding the data packet comprising the created in-packet Bloom filter to a first network node providing at least one service comprised in the set of services.

2. The method of claim 1, wherein the step of creating the in-packet Bloom filter comprises:
performing a logical OR operation on the link identifiers.

3. The method of claim 1, wherein the link identifiers further are configured to identify communication paths of virtual network nodes within the network nodes.

4. The method of claim 1, wherein the link identifiers are defined by a data packet entering point and a data packet exiting point for the communication path on which the data packet is to be routed through said each network node.

5. The method of claim 1, wherein each link identifier is determined by:
performing a Z-function using at least the data packet entering point and the data packet exiting point for the respective communication path as inputs.

6. The method of claim 1, the link identifiers being based on a Media Access Confront (MAC) address of the respective network node.

7. The method of claim 1, the data packet further comprising an address to a destination node to which the packet is to be delivered.

8. The method of claim 1, wherein the step of forwarding the data packet comprises:
multicasting the data packet to the network nodes indicated in the in-packet Bloom filter.

9. The method of claim 8, further comprising:
determining, for each communication path, a first link identifier to be used in case the data packet is forwarded using unicasting, and a second link identifier to be used in case the data packet is forwarded using multicasting.

10. The method of claim 5, wherein each first and second link identifier is determined by:
performing a Z-function using at least the data packet entering point and the data packet exiting point for the respective communication path as inputs and further a unicast identifier for the first link identifier and a multicast identifier for the second link identifier.

11. The method of claim 1, further comprising:
receiving an inquiry from a network node where to forward the data packet; and
sending a temporary in-packet Bloom filter to the inquiring network node where only the link identifier of a next-hop communication path is included.

12. The method of claim 5, further comprising:
using a secret key associated with the respective network node as a further input to the Z-function when determining each link identifier.

13. The method of claim 1, wherein network nodes providing identical services are configured to have identical link identifiers.

14. The method of claim 13, wherein a selected group of data packets is associated with a flow identifier indicating that all the data packets in the group should be routed to the same network node.

15. The method according to claim 1, wherein in case the received data packet subsequently is to be sent to two or more network nodes simultaneously, the link identifier of the respective one of the two or more network nodes is combined in a function resulting in a new link identifier identifying said two or more network nodes, which new link identifier is included in the in-packet Bloom filter.

16. A method of routing a data packet to network nodes providing services in a communications network, comprising:
receiving the data packet at one of the network nodes, said data packet comprising an in-packet Bloom filter;
interpreting the in-packet Bloom filter to determine to which further one of the network nodes the received data packet is to be sent;
forwarding the data packet to said further network node determined by interpreting the in-packet Bloom filter; and
providing at least one service indicated in the data packet.

17. The method of claim 16, wherein the steps of interpreting the in-packet Bloom filter and forwarding the data packet comprise:
acquiring a link identifier for each communication path on which the network node receiving the data packet is capable of routing the data packet to further network nodes;
comparing the link identifier for each communication path with the in-packet Bloom filter, and
forwarding the data packet on the communication path identified by the link identifier for which there is a match with the in-packet Bloom filter.

18.-20. (canceled)

21. The method of claim 17, wherein each link identifier is determined by:
performing a Z-function using at least the data packet entering point and the data packet exiting point for the respective communication path as inputs.

22. The method of claim 17, wherein in case there is a match between the in-packet Bloom filter and two or more link identifiers, the method further comprises:
comparing, with the in-packet Bloom filter, a next-hop communication path link identifier for each of the two or more network nodes for which there was a match, and
dismissing each of the two or more network nodes for which there is no match between the next-hop communication path link identifier and the in-packet Bloom filter as a false positive.

23. The method of claim 16, further comprising:
sending an inquiry to an issuer of the in-packet Bloom filter, in case it cannot be determined from the in-packet Bloom filter to which further network node the data packet should be forwarded; and
receiving, in response to the sent inquiry, a temporary in-packet Bloom filter where only the link identifier of a next-hop communication path is included.

24.-27. (canceled)

28. The method of claim 17, further comprising:
sending an inquiry to an issuer of the in-packet Bloom filter where to forward the data packet; and
receiving a temporary in-packet Bloom filter where only the link identifier of a next-hop communication path is included.

29. (canceled)

30. The method of claim 17, wherein network nodes providing identical services are configured to have identical link identifiers.

31.-32. (canceled)

33. The method of claim 17, wherein in case two or more nodes provide a same service as indicated by two or more identical link identifiers, a receiving node determines to which one of the two or more nodes the data packet is to be transferred.

34. The method of claim 17, further comprising:
returning the data packet to an issuer of the in-packet Bloom filter with complementing information where to forward the data packet; and
receiving an updated in-packet Bloom filter where one or more link identifiers indicated in said complementing information has been included.

35. The method of claim 17, further comprising:
updating the in-packet Bloom filter with new link identifiers to create an updated in-packet Bloom filter; and
adding the updated in-packet Bloom filter to the data packet.

36. A device for determining routing of a data packet to network nodes providing services in a communications network, the device comprising a processing unit and a memory, said memory containing instructions executable by said processing unit, whereby said device is operative to:
receive the data packet;
derive, from the data packet, information pertaining to a set of services to be provided by the network nodes;
determine at least one link identifier for each network node to which the data packet should be routed for the set of services to be provided, each link identifier being configured to identify a communication path on which the data packet is to be routed through said each network node;
create an in-packet Bloom filter on the basis of the link identifiers and adding the in-packet Bloom filter to the received data packet, said in-packet Bloom filter indicating to which network nodes the data packet should be routed for the set of services to be provided; and
forward the data packet comprising the created in-packet Bloom filter to a first network node providing at least one service comprised in the set of services.

37.-59. (canceled)
